(19) United States
(12) Patent Application Publication
(10) Pub. No.: US 2002/0198704 A1
(43) Pub. Date: Dec. 26, 2002

(54) Speech processing system

(75) Inventors: Jebu Jacob Rajan, Berkshire (GB); Jason Peter Andrew Charlesworth, Surrey (GB)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/157,824

(22) Filed: May 31, 2002

(30) Foreign Application Priority Data
Jun. 7, 2001 (GB) 0113889.0

(51) Int. Cl. G10L 11/06

(52) U.S. Cl. 704/214

(57) ABSTRACT

A speech detection system is described which uses a time series noise model to represent audio signals corresponding to noise. The system compares incoming audio signals with the noise model and determines the beginning or end of speech in the audio signal depending on how well the input audio compares to the noise model.

The present invention relates to an apparatus for and method of speech processing. The invention has particular, although not exclusive relevance to the detection of speech within a speech signal.

In some applications, such as speech recognition, speaker verification and voice transmission systems, the microphone used to convert the user's speech into a corresponding electrical signal is continuously switched on. Therefore, even when the user is not speaking, there will constantly be an output signal from the microphone corresponding to silence or background noise. In order (i) to prevent unnecessary processing of this background noise signal; (ii) to prevent mis-recognitions caused by the noise; and (iii) to increase overall performance, such systems employ speech detection circuits which continuously monitor the signal from the microphone and which only activate the main speech processing system when speech is identified in the incoming signal.

Detecting the presence of speech within an input speech signal is also necessary for adaptive speech processing systems which dynamically adjust weights of a filter either during speech or silence portions. For example, in adaptive noise cancellation systems, the filter coefficients of the noise filter are only adapted when noise is present. Alternatively still, in systems which employ an adaptive beam forming to suppress noise from one or more sources, the weights of the beam former are only adapted when the signal of interest is not present within the input signal (i.e. during silence periods). In these systems, it is therefore important to know when the desired speech to be processed is present within the input signal.

Most prior art speech detection circuits detect the beginning and end of speech by monitoring the energy within the input signal, since during silence the signal energy is small but during speech it is large. In particular, in conventional systems, speech is detected by comparing an energy measure with a threshold and indicating that speech has started when the energy measure exceeds this threshold. In order for this technique to be able to accurately determine the points at which speech starts and ends (the so called end points), the threshold has to be set near the noise floor. This type of system works well in environments with a low constant level of noise. It is not, however, suitable in many situations where there is a high level of noise which can change significantly with time. Examples of such situations include in a car, near a road or any crowded public place. The noise in these environments can mask quieter portions of speech and changes in the noise level can cause noise to be incorrectly detected as speech.

One aim of the present invention is to provide an alternative speech detection system for detecting speech within an input signal which can be used in any of the above systems.

According to one aspect, the present invention provides a system for detecting a boundary between speech and noise in an input audio signal, the system comprising: means for receiving an audio signal; means for comparing portions of the audio signal with a noise model and means for detecting the boundary between speech and noise in dependence upon the comparisons performed by said comparing means. The noise model is preferably a time series model which may be generated in advance by analysing segments of background noise. The noise model is preferably used to define a whitening filter through which the input audio signal is passed. The energy of the signal output from the whitening filter is then used to detect the boundary between speech and noise.

Exemplary embodiments of the present invention will now be described with reference to the accompanying drawings in which:

FIG. 1 is a schematic block diagram of a speech recognition system having a speech end point detection system embodying the present invention;

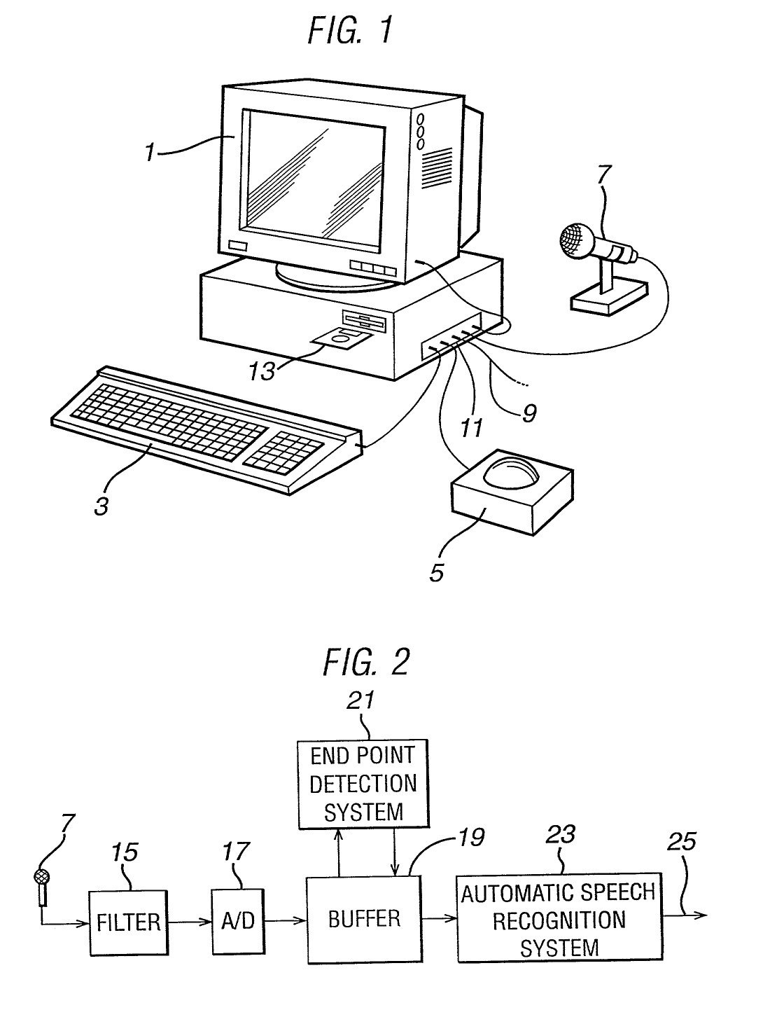

FIG. 2 is a flow chart illustrating processing steps performed by the speech end point detection system shown in FIG. 1 during a training unit;

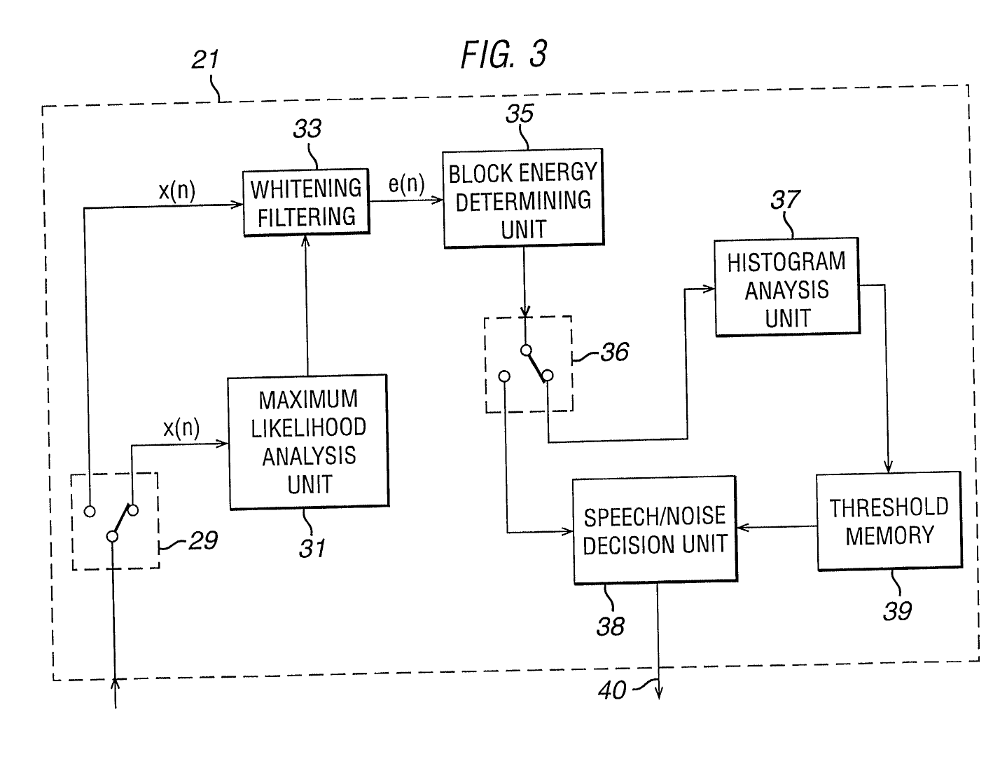

FIG. 3 is a block diagram illustrating the main processing units in the speech end point detection system which forms part of FIG. 1;

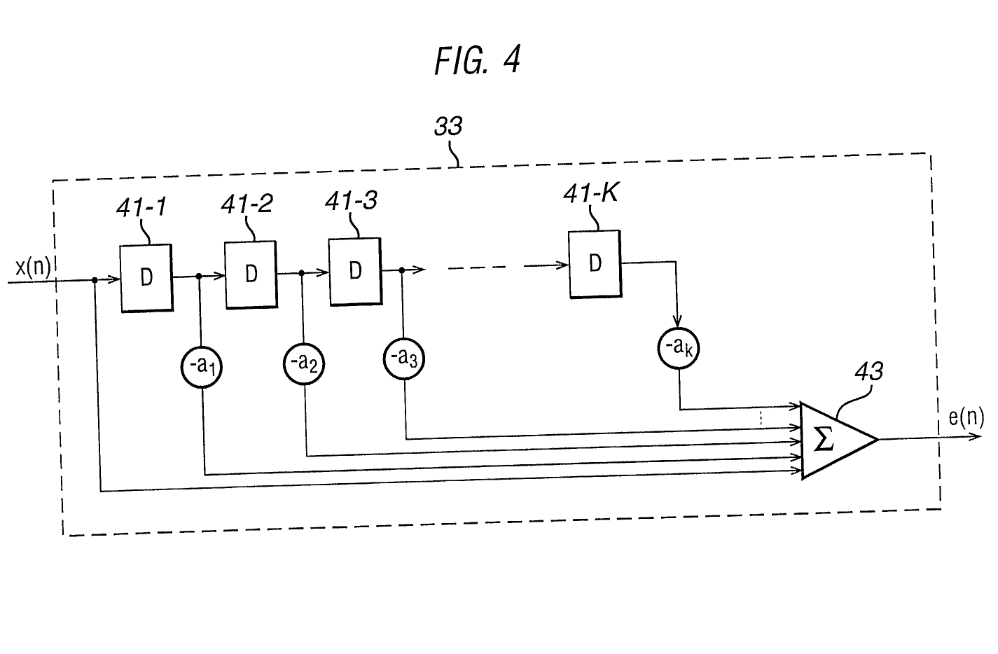

FIG. 4 is a block diagram illustrating the components of a whitening filter which forms part of the speech end point detection system shown in FIG. 3;

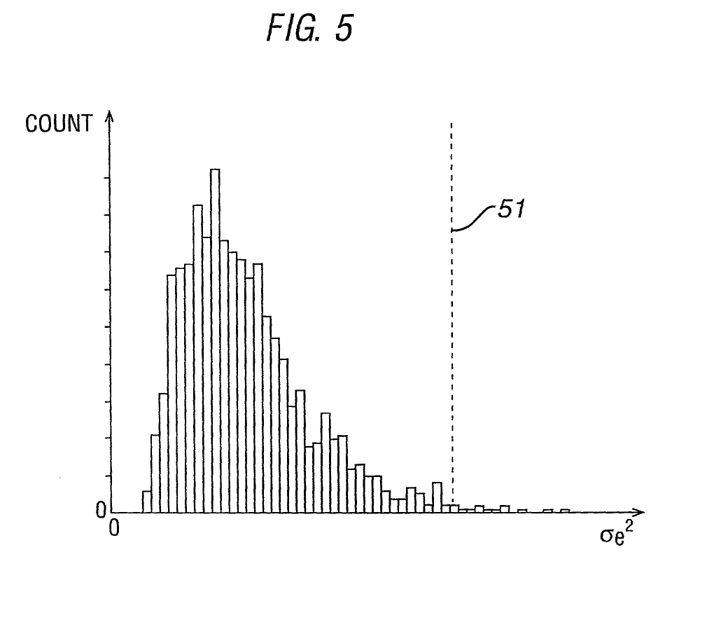

FIG. 5 is a histogram illustrating the variation of a residual energy signal for a section of background noise used in the training operation;

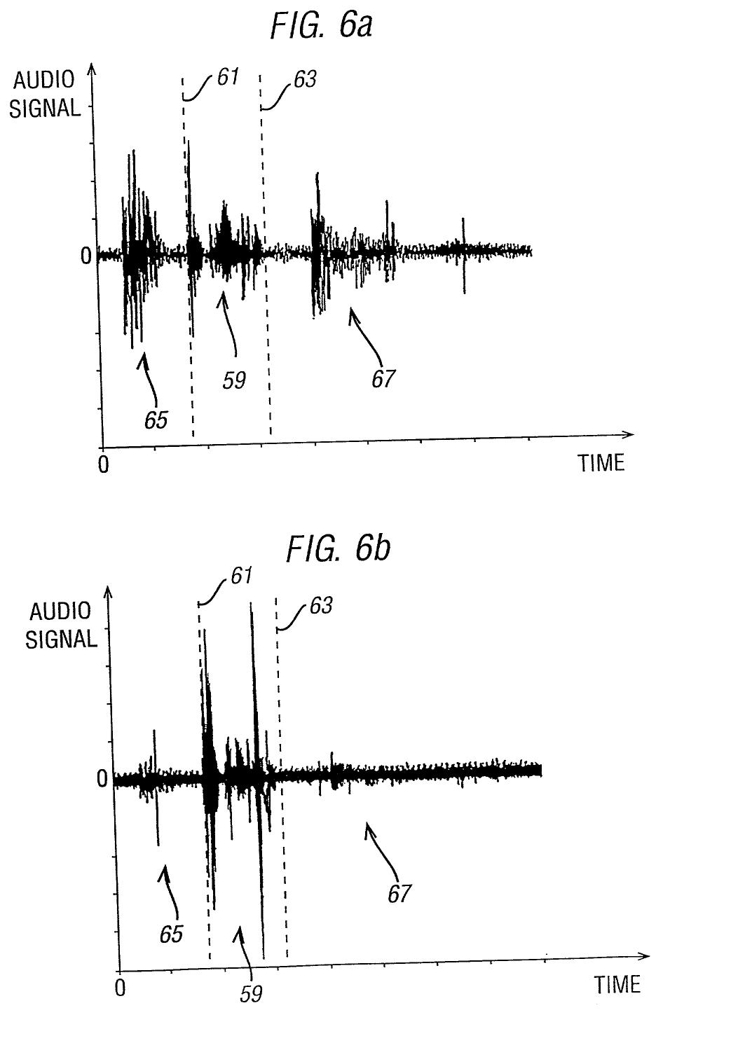

FIG. 6A is a signal diagram illustrating the form of an example speech signal output from the microphone in response to a user's utterance;

FIG. 6B illustrates the form of a filtered residual signal output by the whitening filter shown in FIG. 5 when the speech signal shown in FIG. 6A is applied to its input.

Embodiments of the present invention can be implemented on computer hardware, but the embodiment to be described is implemented in software which is run in conjunction with processing hardware such as a personal computer, work station, photocopier, facsimile machine or the like.

### OVERVIEW

FIG. 1 shows a personal computer (PC) 1 which may be programmed to operate an embodiment of the present invention. A keyboard 3, a pointing device 5, a microphone 7 and a telephone line 9 are connected to the PC 1 via an interface 11. The keyboard 3 and pointing device 5 allow the system to be controlled by a user. The microphone 7 converts the acoustic speech signal of the user into an equivalent electrical signal and supplies this to the PC 1 for processing. An internal modem and speech receiving circuit (not shown) may be connected to the telephone line 9 so that the PC 1 can communicate with, for example, a remote computer or with a remote user.

The program instructions which make the PC 1 operate in accordance with the present invention may be supplied for use within an existing PC 1 on, for example, a storage device such as a magnetic disk 13, or by downloading the software from the Internet (not shown) via the internal modem and telephone line 9.

The operation of a speech recognition system which employs a speech detection system embodying the present invention will now be described with reference to FIG. 2. Electrical signals representative of the input speech from the microphone 7 are input to a filter 15 which removes unwanted frequencies (in this embodiment frequencies above 8 kHz) within the input signal. The filtered signal is then sampled (at a rate of 16 kHz) and digitised by the analogue to digital convertor 17 and the digitised speech samples are then stored in a buffer 19. An end point detection system 21 then processes the speech samples stored in the buffer 19 in order to determine the beginning of speech within the input signal and after speech has been detected, to determine the end of speech within the input signal. If the end point detection system 21 determines that the samples being stored in the buffer 19 correspond to background noise, then it inhibits the passing of these samples to an automatic speech recognition system 23, so that unnecessary processing of the received signal is avoided. As soon as the end point detection system detects that the signal being received corresponds to speech, it causes the buffer 19 to pass the corresponding speech samples to the automatic speech recognition system 23.

In response, the automatic speech recognition system compares the received speech signals with stored models to generate a recognition result 25. The automatic speech recognition system 23 may be any conventional speech recognition system.

### END POINT DETECTION SYSTEM

In this embodiment, the end point detection system 21 models background noise by an auto-regressive (AR) model. This enables a wide variety of ambient noises to be represented. The auto-regressive model is computationally cheap and parameter updates are easily performed. The auto-aggressive model is determined from a section of training noise which is input during a training period. Once trained, the end point detection system 21 compares sections of the audio signal with this model and sections which match well with the model are specified as noise, whilst sections of the audio signal which deviate from this model are specified as speech.

A more detailed description of the end point detection system 21 will now be given with reference to FIGS. 3 to 7. As mentioned above, in this embodiment, the end point detection system 21 models the background noise as an auto regressive (AR) model. In other words, the end point detection system 21 assumes that there is some correlation between neighbouring background noise samples such that a current background noise sample (x(n)) can be determined from a linear weighted combination of the most recent previous background noise samples, i.e.:

x(n)=a₁x(n−1)+a₂x(n−2)+ . . . +aₖx(n−k)+e(n) (1)

Where a₁, a₂ . . . aₖ are the AR filter coefficients representing the amount of correlation between the noise samples; k is the AR filter model order (in this embodiment k is set to a value of 4); and e(n) represents a random residual error of the model. In this embodiment, the end point detection system 21 assumes that the AR filter coefficients for the background noise are constant and estimates for these coefficient values are determined from a maximum likelihood analysis of a section of training background noise. Therefore, considering all N training samples being processed in this training stage gives:

$$\begin{matrix}x ( n ) = {a}_{1} x ( n - 1 ) + {a}_{2} x ( n - 2 ) + … + {a}_{k} x ( n - k ) + e ( n ) \\ x ( n - 1 ) = {a}_{1} x ( n - 2 ) + {a}_{2} x ( n - 3 ) + … + {a}_{k} x ( n - k - 1 ) + e ( n - 1 ) \\ ⋮ \\ x ( n - N + 1 ) = {a}_{1} x ( n - N ) + {a}_{2} x ( n - N - 1 ) + … + {a}_{k} x ( n - k - N + 1 ) + e ( n - N + 1 )\end{matrix} \qquad ( 2 )$$

which can be written in vector form as:

x(n)=X.a+e(n) (3)

where

$$X = {[ \begin{matrix}x ( n - 1 ) & x ( n - 2 ) & x ( n - 3 ) & … & x ( n - k ) \\ x ( n - 2 ) & x ( n - 3 ) & x ( n - 4 ) & … & x ( n - k - 1 ) \\ x ( n - 3 ) & x ( n - 4 ) & x ( n - 5 ) & … & x ( n - k - 2 ) \\ ⋮ & & & ⋰ & \\ x ( n - N ) & x ( n - N - 1 ) & x ( n - N - 2 ) & … & x ( n - k - N + 1 )\end{matrix} ]}_{Nx k}$$

$$\text{and}$$

$$\underline{a} = {[ \begin{matrix}{a}_{1} \\ {a}_{2} \\ {a}_{3} \\ ⋮ \\ {a}_{k}\end{matrix} ]}_{kxl} \underline{x} ( n ) = {[ \begin{matrix}x ( n ) \\ x ( n - 1 ) \\ x ( n - 2 ) \\ ⋮ \\ x ( n - N + 1 )\end{matrix} ]}_{Nxl} \underline{e} ( n ) = {[ \begin{matrix}e ( n ) \\ e ( n - 1 ) \\ e ( n - 2 ) \\ ⋮ \\ e ( n - N + 1 )\end{matrix} ]}_{Nxl}$$

As will be apparent from the following discussion, it is also convenient to re-write equation (2) in terms of the residual error e(n). This gives:

$$\begin{matrix}e ( n ) = x ( n ) - {a}_{1} x ( n - 1 ) - {a}_{2} x ( n - 2 ) - … - {a}_{k} x ( n - k ) \\ e ( n - 1 ) = x ( n - 1 ) - {a}_{1} x ( n - 2 ) - {a}_{2} x ( n - 3 ) - … - {a}_{k} x ( n - k - 1 ) \\ ⋮ \\ e ( n - N + 1 ) = x ( n - N + 1 ) - {a}_{1} x ( n - N ) - {a}_{2} x ( n - N - 1 ) - … - \\ {a}_{k} x ( n - k - N + 1 )\end{matrix} \qquad ( 4 )$$

Which can be written in vector notation as:

e(n)=Äx(n) (5)

where

$$\ddot{A} = {[ \begin{matrix}1 & - {a}_{1} & - {a}_{2} & - {a}_{3} & … & - {a}_{k} & 0 & 0 & 0 & … & 0 \\ 0 & 1 & - {a}_{1} & - {a}_{2} & … & - {a}_{k - 1} & - {a}_{k} & 0 & 0 & … & 0 \\ 0 & 0 & 1 & - {a}_{1} & … & - {a}_{k - 2} & - {a}_{k - 1} & - {a}_{k} & 0 & … & 0 \\ ⋮ & & & & ⋰ & & & & & & \\ 0 & & & & & & & & & & 1\end{matrix} ]}_{NxN}$$

In determining the maximum likelihood values for the AR filter coefficients, the system effectively determines the values of the AR filter coefficients which maximises the joint probability density function for generating the training background noise samples (x(n)), given the AR filter coefficients (a), the AR filter model order (k) and the residual error statistics (σₑ²). Since the samples of background noise are linearly related to the residual errors (see equation 5), this joint probability density function is given by:

$$p ( \underline{x} ( n ) \vert \underline{a} , k , {σ}_{e}^{2} ) = p ( \underline{e} ( n ) ) \vert \frac{δ \underline{e} ( n )}{δ \underline{x} ( n )} \vert \underline{e} ( n ) = \underline{x} ( n ) - X \underline{a} \qquad ( 6 )$$

Where p(e(n)) is the joint probability density function for the residual errors during the section of training background noise and the second term on the right hand side is known as the Jacobian of the transformation. In this case, the Jacobian is unity because of the triangular form of the matrix Ä (see equation(5) above).

In this embodiment, the end point detection system 21 assumes that the residual error associated with the training background noise is Gaussian having zero mean and some unknown variance (σₑ²) The end point detection system 21 also assumes that the residual error at one time point is independent of the residual error at another time point. Therefore, the joint probability density function for the residual errors during the training background noise is given by:

$$p ( \underline{e} ( n ) ) = {( 2 {πσ}_{e}^{2} )}^{- \frac{N}{2}} exp [ \frac{- {\underline{e} ( n )}^{T} \underline{e} ( n )}{2 {σ}_{e}^{2}} ] \qquad ( 7 )$$

Consequently, the joint probability density function for generating the training background noise samples given the AR filter coefficients (a), the AR filter model order (k) and the residual error variance (σₑ²) is given by:

$$p ( \underline{x} ( n ) \vert \underline{a} , k , {σ}_{e}^{2} ) = {( 2 {πσ}_{e}^{2} )}^{- \frac{N}{2}} exp [ \frac{- 1}{2 {σ}_{e}^{2}} ( {\underline{x} ( n )}^{T} \underline{x} ( n ) - 2 {\underline{a}}^{T} X \underline{x} ( n ) + {\underline{a}}^{T} {X}^{T} X \underline{a} ) ] \qquad ( 8 )$$

In order to determine the AR filter coefficients which maximise this probability density function, the system determines the values of the AR filter model which make the differential of equation (8) above zero. This analysis provides the usual maximum likelihood AR filter coefficients:

a^{ML}=(X^{T}X)⁻¹Xx(n) (9)

The determined AR filter coefficients are then used to set the weights of a whitening filter 33 which is designed to determine the residual error generated for each sample of the background noise in accordance with the first line of equation (4) above. The specific structure of the whitening filter 33 is diagrammatically shown in FIG. 4. As shown, the filter comprises k delay elements 41 that are connected in series with each other and through which the background noise samples pass, such that as each new sample is received the previous samples shift one delay element 41 to the right. As shown, the output of delay element 41-1 (which is x(n−1)) is multiplied by weighting −a₁, the output of register 41-2 (which is x(n−2)) is multiplied by weighting −a₂ etc. The weighted values together with the current background noise sample (x(n)) are then summed by the adder 43 to generate the residual error e(n) for the current noise sample x(n).

Once the weights of the whitening filter 33 have been set in this way, the position of the switch 29 is changed so that the audio samples stored in the buffer are passed to the whitening filter 33 instead of the maximum likelihood analyses unit 31. All of the training audio samples are passed through the whitening filter 33 in the manner described above to generate a corresponding residual error value. As shown in FIG. 3, these residual errors are input to a block energy determining unit 35 which divides all the residual error values calculated for all of the training background noise samples into time ordered groups or blocks of errors and then determines a measure of the energy of the residual errors within each block. In particular, in this embodiment the block energy determining unit 35 determines the variance of a block of residual error values (e(i)), as follows:

$${σ}_{{e}_{i}}^{2} = \frac{I}{M} {\underline{e}}^{T} ( i ) \underline{e} ( i ) \qquad ( 10 )$$

where M is the number of residuals in the block and

$$\underline{e} ( i ) = {[ \begin{matrix}e ( i ) \\ e ( i - 1 ) \\ e ( i - 2 ) \\ ⋮ \\ e ( i - M + 1 )\end{matrix} ]}_{Mxl}$$

In this embodiment, one second of background noise is used in the training algorithm which, with the 16 kHz sampling rate, means that approximately 16,000 background noise samples are processed in the maximum likelihood analysis unit 31. Further, in this embodiment, the block energy determining unit 35 divides the residual error values determined for these samples into non-overlapping blocks of approximately eighty samples. Therefore, the block energy determining unit determines approximately 200 energy values for the training background noise. During the training routine, the energy values determined by the block energy determining unit 35 are passed via the switch 36 to a histogram analysis unit 37 which analyses the energy values to determine appropriate threshold values for use in detecting speech.

A typical histogram of the residual error energy within the blocks is shown in FIG. 5. In the illustrated histogram, the determined residual error energy levels only exceed the threshold value shown by the dotted line 51 one per cent of the time. However, when the audio samples correspond to speech, the whitening filter 33 will not have much effect on the speech samples since the speech samples are much more significantly correlated than background noise. Therefore, when speech is passed through the whitening filter 33, the residual error energy for blocks of speech samples will be much higher than those for background noise. Consequently in this embodiment the threshold energy value is set to correspond to the 0.01 percentile level 51 of the inverse Gamma distribution shown in FIG. 5 and is stored in the threshold memory 39.

In this embodiment, two threshold values are actually determined and stored within the threshold memory 39—a coarse threshold value which is used to indicate the start of the signal which is clearly not background noise and a fine threshold value which is used to determine the start point of speech more accurately. In this embodiment, the fine threshold value is the 0.01 percentile energy value discussed above and the coarse threshold value is the 0.05 percentile level.

Once the maximum likelihood AR filter coefficients have been determined for the whitening filter 33 and once the threshold energy levels have been determined, the end point detection system 21 can then be used to detect speech within an input signal. This is done by connecting the input audio signals in the buffer to the whitening filter 33 through the switch 29 and by connecting the output of the block energy determining unit 35 to the speech/noise decision unit 38 through the switch 36. The speech/noise decision unit 38 then compares the energy values calculated for each block of samples (as determined by the block energy determining unit 35) with the threshold energy levels stored in the threshold memory 39. If the residual energy value for the current block being processed is below the thresholds, then the decision unit 38 decides that the corresponding audio corresponds to background noise. However, once the speech/noise decision unit 38 determines that there are a number of consecutive blocks (e.g. five consecutive blocks) whose residual energy values exceed the coarse threshold, then the decision unit 38 determines that the corresponding audio is speech. As those skilled in the art will appreciate, searching for a number of consecutive blocks for which the residual energy values exceed the coarse threshold minimises false detection of speech due to spurious short sounds or noises. The decision unit 38 then uses the fine threshold to find the start point of the speech within these audio samples more accurately.

Once the decision unit 38 determines the starting point of speech within the audio samples, it sends an output signal 40 to the buffer 19 which causes the audio samples received after the determined start point to be passed to the speech recognition system 23 for recognition processing. As those skilled in the art will appreciate, after the start of speech has been detected, the end point detection system 21 then continues to analyse the received audio data in the manner described above in order to detect the end of speech. The only difference is that the decision unit 38 looks for a number of consecutive blocks for which the residual error is below the fine threshold. When the decision unit 38 detects this, it sends another control signal 40 to the buffer to prevent audio signals after the detected end point from being passed to the automatic speech recognition system 23.

FIG. 6 illustrates the accuracy with which the end point detection system 21 can detect speech within an input signal using this technique. In particular, FIG. 6a schematically illustrates an input signal having a speech portion 59 bounded by the dashed lines 61 and 63 and which shows significant breath noise 65 and 67 both before and after the speech portion 59. FIG. 6b shows the residual error of the signal after being passed through the whitening filter 33. As shown, the areas corresponding to the breath noise are attenuated and the sections of actual speech are enhanced relative to the rest of the signal. Therefore, thresholding the signal shown in FIG. 6b leads to a more accurate determination of the start and end points of speech within the input signal and reduced false detection of signal components which are not speech.

### MODIFICATIONS AND ALTERNATIVE EMBODIMENTS

A specific embodiment has been described above which illustrates the principles behind the end point detection technique of the present invention. However, as those skilled in the art will appreciate, various modifications can be made to the embodiment described above without departing from the concept of the present invention. A number of these modifications will now be described to illustrate this.

In the above embodiment, an autoregressive model was used to model the background noise observed during the training routine. However, other models may be used. For example, an Auto Regressive Moving Average (ARMA) model could be used.

In the above embodiment, a maximum likelihood analysis was performed on the training samples of background noise in order to derive a model for the noise. As those skilled in the art will appreciate, other analyses techniques can be used to determine appropriate coefficient values for the noise model. For example, maximum entropy techniques or other AR processes with other distributions, such as Laplacian distributions could be used.

In the above embodiment, in order to determine whether the incoming audio samples correspond to background noise or speech, the samples are passed through a whitening filter which is generated from the model of the background noise. The energy of the output signal from the whitening filter is then used to determine whether or not the input audio samples correspond to noise or speech. However, as those skilled in the art will appreciate, other techniques can be used to determine whether or not the incoming audio samples matches the noise model determined during the training stage. For example, the end point detector could dynamically calculate the AR coefficients for the incoming signal and then use a pattern matcher to compare the AR coefficients thus calculated with the AR coefficients calculated for the training background noise.

In the above embodiment, the speech/noise decision unit used two threshold values in determining whether or not the incoming audio was speech or noise. As those skilled in the art will appreciate, other decision strategies may be used. For example, the decision unit may decide that the input audio corresponds to speech as soon as a predetermined threshold value has been exceeded, however, such an embodiment is not preferred because it is susceptible to false detection of speech due to spurious short sounds or noises. Similarly, when detecting the end of speech, both the fine threshold and the coarse threshold could be used rather than just the fine threshold.

In the above embodiment, the whitening filter is determined in advance from the set of training background noise samples. In an alternative embodiment, the filter coefficients of the whitening filter may be adapted in order to take into account changing background noise levels. This may be done, for example, by using adaptive filter techniques to adapt the filter coefficients when the decision unit decides that the current input signal corresponds to background noise. A least mean square (LMS) algorithm may be used to determine the appropriate changes to be made to the filter coefficients. Alternatively, the end point detection system may model the distribution of residuals (shown in FIG. 5) with, for example, an inverse Gamma or a Rayleigh distribution, and then adapt the mean of the residual energy distribution (shown in FIG. 5) which in turn adapts the threshold values since they are dependent upon the mean of the distribution. These adaptive techniques will therefore compensate for changes in environmental noise conditions and they will ensure that the noise model is always up-to-date.

1. An apparatus for detecting a boundary between a speech portion and a noise portion of an input audio signal, the apparatus comprising:
a memory storing data defining a time series model which relates a plurality of previous noise audio samples to a current noise audio sample;
means for receiving a time sequential series of audio samples representative of the input audio signal;
means for comparing a plurality of groups of audio samples with said time series model to determine for each group a measure which represents how well the time series model represents the audio samples in the corresponding group; and
means for detecting said boundary between said speech portion and said noise portion of said input audio signal using said determined measures.

2. An apparatus according to claim 1, wherein said data defines an autoregressive time series model.

3. An apparatus according to claim 1, wherein said comparing means comprises a filter derived from said time series model.

4. An apparatus according to claim 3, wherein said filter is a whitening filter.

5. An apparatus according to claim 1, wherein said detecting means is operable to group said measure determined by said comparing means for consecutive groups of audio samples into sets of said measures and wherein said detecting means is operable to determine an energy measure for the measures within each set and is operable to use said energy measures to detect said boundary.

6. An apparatus according to claim 5, wherein said detecting means is operable to detect said boundary by comparing said energy measures with a predetermined threshold.

7. An apparatus according to claim 6, wherein said detecting means is operable to compare said energy measures with a coarse threshold value and with a fine threshold value.

8. An apparatus according to claim 5, wherein said energy measure for a set comprises the variance of the measures within said set.

9. An apparatus according to claim 1, further comprising means for varying the data defining said time series model.

10. An apparatus according to claim 9, wherein said varying means is responsive to the detection made by said detecting means.

11. An apparatus according to claim 9, further comprising means for inhibiting the operation of said varying means during said speech portion of said input audio signal.

12. An apparatus according to claim 1, wherein said detecting means is operable to detect an end point of speech within the audio signal using said determined measures.

13. An apparatus according to claim 1, wherein said detecting means is operable to detect a beginning point of speech within the audio signal using said determined measures.

14. An apparatus according to claim 1, having a training mode of operation in which a time sequential series of noise samples are processed to determine said data defining said time series model; and a boundary detection mode in which said audio samples are compared with said data defining said time series model to determine the location of said boundary in the audio samples.

15. An apparatus according to claim 14, wherein in said training mode, said data defining said time series model is determined using a maximum likelihood analysis of the input noise samples.

16. A method of detecting a boundary between a speech portion and a noise portion of an input audio signal, the method comprising the steps of:
storing data defining a time series model which relates a plurality of previous noise audio samples to a current noise audio sample;
receiving a time sequential series of audio samples representative of the input audio signal;
comparing a plurality of groups of audio samples with said time series model to determine for each group a measure which represents how well the time series model represents the audio samples in the corresponding group; and
detecting said boundary between said speech portion and said noise portion of the input audio signal using said determined measures.

17. A method according to claim 16, wherein said data defines an autoregressive time series model.

18. A method according to claim 16, wherein said comparing step uses a filter derived from said time series model.

19. A method according to claim 18, wherein said filter is a whitening filter.

20. A method according to claim 16, wherein said detecting step groups said measure determined by said comparing step for consecutive groups of audio samples into sets of said measures and wherein said detecting step determines an energy measure for the measures within each set and uses said energy measures to detect said boundary.

21. A method according to claim 20, wherein said detecting step detects said boundary by comparing said energy measures with a predetermined threshold.

22. A method according to claim 21, wherein said detecting step compares said energy measures with a coarse threshold value and with a fine threshold value.

23. A method according to claim 20, wherein said energy measure for a set comprises the variance of the measures within said set.

24. A method according to claim 16, further comprising the step of varying the data defining said time series model.

25. A method according to claim 24, wherein said varying step is responsive to the detection made by said detecting step.

26. A method according to claim 23, further comprising the step of inhibiting the operation of said varying step during a speech portion of said input audio signal.

27. A method according to claim 16, wherein said detecting step detects an end point of speech within the audio signal using said determined measures.

28. A method according to claim 16, wherein said detecting step detects a beginning point of speech within the audio signal using said determined measures.

29. A method according to claim 16, having a training step in which a time sequential series of noise samples are processed to determine said data defining said time series model; and a speech detection step in which said audio samples are compared with said data defining said time series model to determine the start point of speech in the audio samples.

30. A method according to claim 29, wherein in said training step, said data defining said time series model is determined using the maximum likelihood analysis of the input noise samples.

31. A computer readable medium storing computer executable instructions for causing a processor to carry out the method of claim 16.

32. Computer executable instructions for causing a processor to carry out the method of claim 16.
